(19) United States
(12) Patent Application Publication
(10) Pub. No.: US 2015/0300828 A1
(43) Pub. Date: Oct. 22, 2015

(54) COOPERATIVE LEARNING METHOD FOR ROAD INFRASTRUCTURE DETECTION AND CHARACTERIZATION

(71) Applicant: FORD GLOBAL TECHNOLOGIES, LLC, Dearborn, MI (US)

(72) Inventors: Fling TSENG, Ann Arbor, MI (US); Hai YU, Canton, MI (US)

(73) Assignee: FORD GLOBAL TECHNOLOGIES, LLC, Dearborn, MI (US)

(21) Appl. No.: 14/255,484

(22) Filed: Apr. 17, 2014

(51) Int. Cl. G01C 21/32

(52) U.S. Cl. CPC G01C 21/32

(57) ABSTRACT

A method for generating street map data includes collecting acceleration, turning, and geolocation data. The data is collected from acceleration sensors, turning sensors, and geolocation systems in at a least one vehicle across a plurality of vehicle drive cycles. The method additionally includes aggregating the acceleration, turning, and geolocation data. The method further includes predicting the presence of a traffic control device in response to an identified repetitive pattern in the aggregated data. The method further includes updating street map data to include the predicted traffic control device.

### TECHNICAL FIELD

The present disclosure relates to a method for detecting, learning, and characterizing road infrastructure based on data obtained from existing sensors in automotive vehicles.

### BACKGROUND

Many automotive vehicles are provided with navigation systems. These navigation systems may be factory-installed by the manufacturer, aftermarket, or standalone devices such as a portable GPS or a cellular phone. In all forms of navigation systems, it is desirable to include complete and up-to-date mapping data. This mapping data may include points of interest along with road infrastructure information regarding the physical layout of the streets, street restrictions (e.g. one way streets or vehicle height limits) and information regarding traffic control devices and signage.

### SUMMARY

A method for generating street map data includes collecting acceleration, turning, and geolocation data. The data is collected from acceleration sensors, turning sensors, and geolocation systems in at a least one vehicle across a plurality of vehicle drive cycles. The method further includes predicting the presence of a traffic control device at a geolocation in response to an identified repetitive pattern in the data. The method further includes updating street map data to include the predicted traffic control device at the geolocation.

In one embodiment, the identified repetitive pattern comprises a plurality of vehicle stops at the geolocation across a plurality of drive cycles.

One such embodiment further includes defining a first time interval corresponding to a vehicle stop at a stop sign, a second time interval corresponding to a vehicle stop at a crosswalk, a third time interval corresponding to a yield sign, and a fourth time interval corresponding to a traffic light. In such an embodiment, predicting the presence of a traffic control device comprises correlating the plurality of vehicle stops at the geolocation with the first, second, third, or fourth time intervals.

Another such embodiment includes defining a first stop probability corresponding to a vehicle stop at a stop sign, a second stop probability corresponding to a vehicle stop at a crosswalk, a third stop probability corresponding to a yield sign, and a fourth stop probability corresponding to a traffic light. In such an embodiment, predicting the presence of a traffic control device comprises calculating a percentage of vehicle trips through the geolocation that are vehicle stops, and correlating the percentage of stops with one the first, second, third, or fourth stop probabilities.

In a further embodiment, predicting the presence of a traffic control device includes predicting the presence of a stoplight at an intersection. The stoplight is predicted in response to an identified geolocation at which a pattern of first and second driving modes occurs. The first mode includes driving toward and through the intersection at a first heading without stopping. The second mode includes driving toward the intersection at the first heading and stopping before driving through.

A mapping system according to the present disclosure includes one or more computing devices configured to aggregate collected data, where the collected data includes driver actuations of vehicle controls and corresponding geolocations. The computing devices are additionally configured to infer the presence of a discrepancy in mapping data in response to an identified repetitive driving pattern among the aggregated data. The computing devices are further configured to update the mapping data to correct the discrepancy.

In one embodiment, the driver actuations of vehicle controls include accelerator pedal actuation, brake pedal actuation, or steering wheel rotation. In another embodiment, inferring the presence of a discrepancy in mapping data includes predicting the presence of a traffic control device in response to a plurality of vehicle stops at a geolocation at which no traffic control device is indicated in the mapping data. In a further embodiment, inferring the presence of a discrepancy in mapping data includes predicting the presence of a road in response to a plurality of vehicle turns from a first vehicle heading to a second vehicle heading at a geolocation at which no road is indicated in the direction of the second vehicle heading.

A method of generating mapping data includes generating mapping data including a predicted geolocation of a traffic control device. The geolocation of the traffic control device is predicted in response to a repeated driving pattern at the geolocation. The repeated driving pattern is identified among collected acceleration, turning, and geolocation data from acceleration sensors, turning sensors, and geolocation systems in at least one vehicle across a plurality of vehicle drive cycles.

In one embodiment of the method, the repeated driving pattern comprises a plurality of vehicle stops at the geolocation across the plurality of drive cycles.

One such embodiment further includes defining a first time interval corresponding to a vehicle stop at a stop sign, a second time interval corresponding to a vehicle stop at a crosswalk, a third time interval corresponding to a yield sign, and a fourth time interval corresponding to a traffic light. In such an embodiment, predicting the presence of a traffic control device comprises correlating the plurality of vehicle stops at the geolocation with the first, second, third, or fourth time intervals.

Another such embodiment includes defining a first stop probability corresponding to a vehicle stop at a stop sign, a second stop probability corresponding to a vehicle stop at a crosswalk, a third stop probability corresponding to a yield sign, and a fourth stop probability corresponding to a traffic light. In such an embodiment, predicting the presence of a traffic control device comprises calculating a percentage of vehicle trips through the geolocation that are vehicle stops, and correlating the percentage of stops with one the first, second, third, or fourth stop probabilities.

In a further embodiment, the predicted traffic control device is a stoplight. In such an embodiment, the repeated driving pattern at the geolocation includes a pattern of first and second driving modes. The first mode includes driving toward and through an intersection at a first heading without stopping. The second mode includes driving toward the intersection at the first heading and stopping before driving through.

Embodiments according to the present disclosure provide a number of advantages. For example, the present disclosure provides a method for learning road infrastructure information using data from existing sensors in a vehicle. Furthermore, the infrastructure data may be automatically obtained from “crowd-sourced” sensor data from a plurality of customer vehicle trips, rather than through more expensive or time-intensive methods.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 illustrates a vehicle in schematic form;

FIG. 2 illustrates a system for updating mapping data in schematic form;

FIG. 3 illustrates a method for updating mapping data in flowchart form;

FIG. 4 illustrates a classification system for identifying vehicle stopping patterns according to traffic control device; and

FIG. 5 illustrates sample data for vehicle stops across a plurality of vehicle drive cycles, in response to which mapping data may be updated.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In vehicle navigation systems, it is desirable to include complete and up-to-date mapping data. Mapping data may be acquired in various ways. Traditionally, commercial users would license map data from mapping specialist companies, such as NAVTEQ, or government agencies, such as the Ordnance Survey in Great Britain. In recent years, navigation programs for data-equipped devices cellular phones have been equipped to transfer geolocation data to data collectors for processing. This collected geolocation data may be used, for example, to generate “crowd-sourced” real-time traffic information for dissemination to other data-equipped navigation devices.

Crowd-sourcing mapping data collection is useful in that data may be collected from a multitude of users and analyzed to obtain information about roads and road conditions. However, known crowd sourcing implementations collect and transfer only geolocation data. This data can be analyzed to determine position and speed, but the available information is limited.

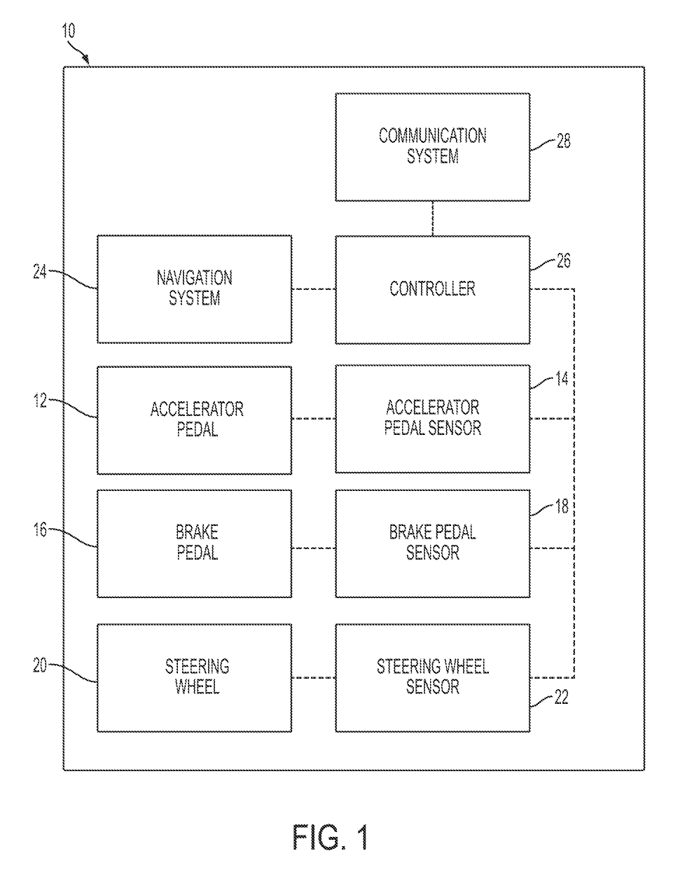

Referring to FIG. 1, a vehicle 10 according to the present disclosure is illustrated in schematic form. The vehicle 10 includes an accelerator pedal 12 in communication with an accelerator pedal sensor 14. The vehicle 10 additionally includes a brake pedal 16 in communication with a brake pedal sensor 18. The vehicle 10 further includes a steering wheel 20 in communication with a steering wheel sensor 22. Collectively, the accelerator pedal 12, brake pedal 16, and steering wheel 20 function to receive driver actuations indicative of desired vehicle behavior. The accelerator pedal 14, brake pedal sensor 18, and steering wheel sensor 22 monitor the driver actuations of the accelerator pedal 12, brake pedal 16, and steering wheel 20, respectively, and communicate signals indicative of the actuations to various other vehicle components. The vehicle 10 additionally includes a navigation system 24. The navigation system 24 may be a built-in navigation system or a stand-alone device, such as a portable GPS or a cell phone, that is in communication with the vehicle 10.

At least one vehicle controller 26 is in communication with or controls the accelerator pedal sensor 14, brake pedal sensor 18, steering wheel sensor 22, and navigation system 24. The controller 26 is configured to transmit data from the sensors 14, 18, and 22 and navigation system 24 to a remote processing center via a communications system 28. The communications system 28 is preferably a wireless communications system using cellular data, but may include various other wireless transmission systems such as Bluetooth or wifi or a wired connection. The controller 26 may be configured to send the sensor data in real-time or to store the data for a period and subsequently transmit the stored data. In various embodiments, the controller may be configured to transmit sensor data on a daily basis or after each drive cycle.

Other embodiments may include various other sensors that capture vehicle or driver behavior, such as an accelerometer or a speedometer, in communication with the controller 26. Such sensors provide additional information based on which infrastructure data may be inferred. In such embodiments, the controller 26 may be further configured to send sensor data from these sensors at various intervals as discussed above.

In a preferred embodiment, the data transmission occurs only after a driver “opts in,” or agrees to the data transmission after being informed of the type of data that will be collected. This may be performed via a user interface, such as a touch-enabled display, upon the first or subsequent use of the vehicle.

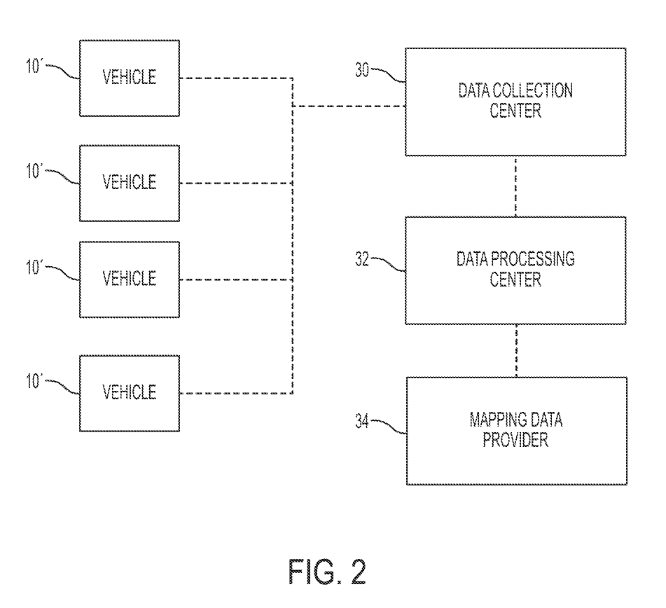

Referring now to FIG. 2, a system for updating mapping data is illustrated in schematic form. A plurality of vehicles 10′ are in communication with a data collection center 30. The vehicles 10′ are configured to transmit sensor data to the data collection center 30, preferably including steering sensor data, brake sensor data, accelerator pedal sensor data, and geolocation data. The data collection center 30 includes at least one computing device that is configured to aggregate the data. In a preferred embodiment, the aggregation includes “anonymizing” the data, or stripping the data of any data or metadata that could be used to identify the vehicle or driver from which the data was obtained.

The data collection center 30 communicates the aggregated data to a data processing center 32. The data processing center 32 includes at least one computing device that is configured to analyze the aggregated data and identify patterns indicative of road infrastructure, such as traffic control devices or physical road layout. In a preferred embodiment, the computing device is provided with existing road infrastructure data and is configured to identify discrepancies in the existing road infrastructure data based on the patterns indicative of road infrastructure. Discrepancies may include road infrastructure information that is missing in the existing data or changes from the existing data, such as traffic control design or configuration changes. The computing device may also be configured to validate existing map data based on patterns in the aggregated data.

The data processing center 32 communicates the discrepancies in road infrastructure data to a mapping data provider 34. The mapping data provider 34 may update existing mapping data to correct the discrepancies in road infrastructure data. The mapping data provider 34 may also issue updated maps including the corrected road infrastructure data.

In some embodiments, the data collection center 30, data processing center 32, and mapping data provider 34 may be combined into a common processing center utilizing common computing devices. In other embodiments, they may be separate as illustrated in FIG. 2 or the functions may be split into a larger number of service providers.

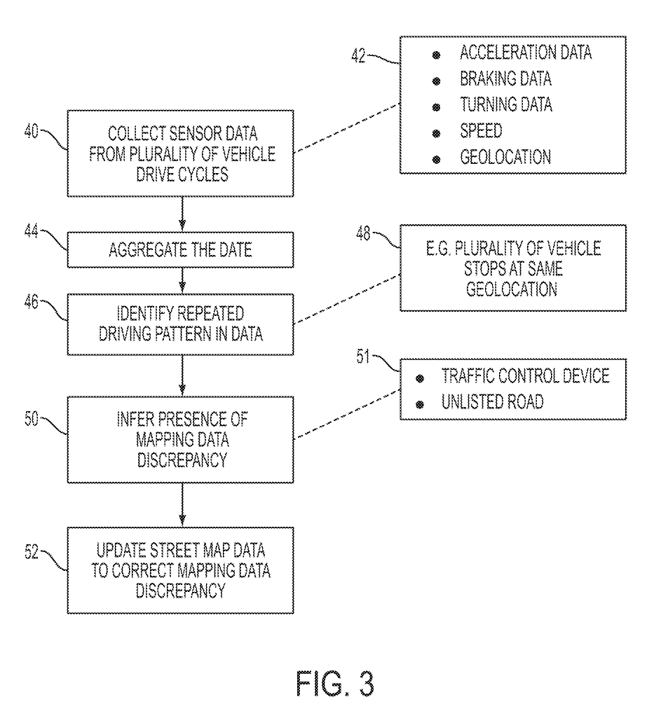

Referring now to FIG. 3, a flowchart illustrates a method for updating mapping data. Data from a plurality of drive cycles is collected, as illustrated at block 40. This sensor data may include a combination of acceleration data from an accelerator pedal, braking data from a brake pedal, turning data from a steering wheel, and geolocation data from a navigation system, as illustrated at block 42.

The collected data is aggregated, as illustrated at block 44. Repeated driving patterns in the aggregated data are identified, as illustrated at block 46. An example of a repeated driving pattern is a plurality of vehicle stops at the same geolocation, as illustrated at block 48. Another example of a repeated driving pattern is a plurality of vehicle turns at the same geolocation. The presence of a mapping data discrepancy is inferred in response to the identified pattern, as illustrated at block 50. Examples of mapping data discrepancies include a traffic control device that is not present in the mapping data or an unlisted road, as illustrated at block 51. Street map data is updated to correct the mapping data discrepancy, as illustrated at block 52. This may comprise adding the traffic control device to the map data or adding the unlisted road to the map data.

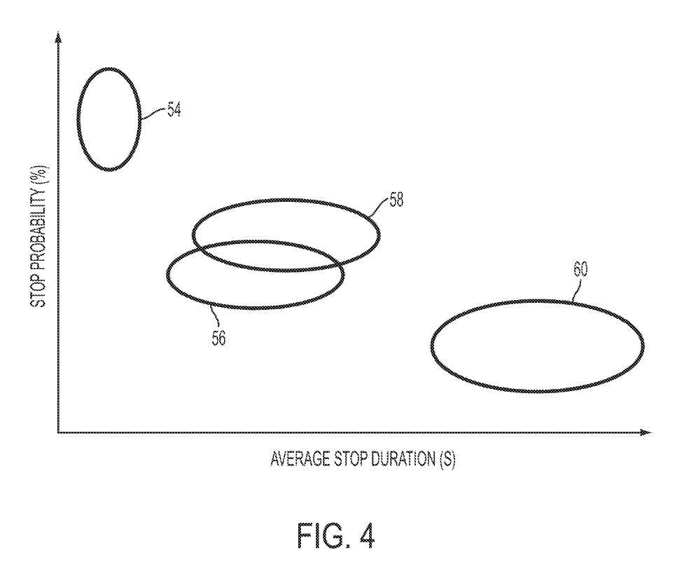

Referring now to FIG. 4, a classification system for identifying vehicle stopping patterns according to traffic control device is illustrated. For each of a variety of traffic control devices, a stop probability range and stop duration range are defined. The stop probability range and stop duration range may be defined in response to data from drive testing, simulation, or other appropriate methods.

A sample stop probability range and stop duration range for a stop sign are illustrated at 54. At a stop sign, typical driver behavior is to briefly come to a full stop, then proceed forward at a same heading. Thus, a location at which vehicles are highly likely to stop for a short time may be identified as a stop sign location.

A sample stop probability range and stop duration range for a yield sign are illustrated at 56. At a yield sign, typical driver behavior is to slow the vehicle while checking for traffic, and only come to a full stop if necessary. As yield signs are frequently located at intersections where minor roads cross or join more major roads, vehicle stops may be more lengthy than those at stop signs. Thus, a location at which vehicles are moderately likely to stop for an intermediate time may be identified as a yield sign location.

A sample stop probability range and stop duration range for a crosswalk are illustrated at 58. At a crosswalk, typical driver behavior is to slow the vehicle to a stop when pedestrians are present and wait for the pedestrians to cross the street prior to resuming travel. While this driving pattern is generally similar to that at a yield sign, experimental data has shown that the average vehicle stop probability and average stop duration are both slightly higher at a crosswalk.

A sample stop probability range and stop duration range for a stop light are illustrated at 60. At a stop light, typical driver behavior varies between two modes. In a first mode where the light is green, the driver continues through the intersection without stopping. In a second mode where the light is yellow or red, the driver stops until the light turns green and subsequently proceeds through the intersection. Stop lights typically remain red for a duration that is longer than a typical vehicle stop at a stop sign. Thus, a location at which vehicles are less likely to stop for a longer time may be identified as a stop light location.

Some stop lights present varying signal durations according to the time of day. As an example, the stop light may provide a longer green signal for one road at an intersection during rush hour to promote vehicle travel along that road. In one embodiment, the method includes inferring the presence of a variable duration stop light in response to a varying probability of vehicle stops with varying durations, where the probability and duration of the stops vary in a repeating pattern across daily and/or weekly cycles.

A computer algorithm may be provided with stop probability and stop duration ranges, which may be determined, for example, by experimental data. The algorithm may additionally be configured to analyze data including a plurality of vehicle stops at a geolocation across a plurality of drive cycles and classify the geolocation according to the categories of traffic control devices. In various embodiments this may be performed by classifying the geolocation as a single traffic control device according to a “best match” method, or by using a fuzzy classification system and calculating an affinity variable for each of the categories of traffic control devices.

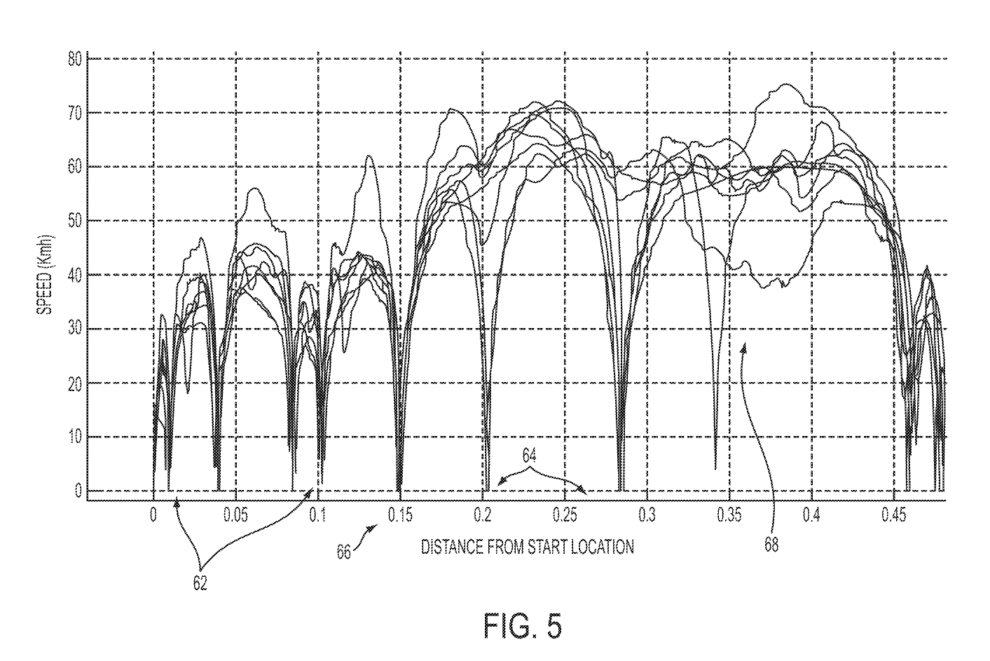

Referring now to FIG. 5, example data indicating vehicle stops across a plurality of vehicle drive cycles are illustrated. In the example data, a plurality of vehicle drive cycles along a same route are provided in order to more clearly illustrate the disclosed method of identifying traffic control devices. However, aggregated data from a plurality of vehicles traveling a plurality of routes may easily be used as well.

At certain locations on the route, such as those indicated at numeral 62, the vehicle is likely to slow down substantially, but only infrequently comes to a full stop. Furthermore, as can be observed in the data, the distance across which the vehicle rolls at low speed varies among the plurality of vehicle drive cycles. These locations may thus be classified as cross walks or yield signs.

At other locations, such as those indicated at reference numeral 64, the vehicle will come to a full stop on some drive cycles and not on others. In addition, it may be observed that on some drive cycles the vehicle decelerates substantially more rapidly than other drive cycles. These locations may thus be classified as traffic lights.

At locations such as are illustrated at numeral 66, the vehicle comes to a full stop on every drive cycle. Such a location may thus be classified as a stop sign.

At some locations, such as are illustrated at numeral 68, the vehicle speed varies substantially, and on occasion the vehicle comes to a near or full stop. Such a pattern is indicative of variable traffic patterns, and not of a traffic control device.

Variations on the above-described system and method are, of course, possible. For example, in some embodiments, additional categories of traffic control devices may be defined based on experimental data. In other embodiments, vehicle turning data from a plurality of vehicle drive cycles may be analyzed to identify roads that are unlisted in the map database. Furthermore, in some embodiments, a driver's individual driving patterns at known traffic control devices may be learned in order to more effectively classify unknown traffic control devices.

As can be seen from the various embodiments, the present invention provides a system and method for learning road infrastructure information using data from existing sensors in a vehicle. Furthermore, the infrastructure data may be automatically obtained from crowd-sourced sensor data from a plurality of customer vehicle trips.

While the best mode has been described in detail, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments discussed herein that are described as less desirable than other embodiments or prior art implementations with respect to one or more characteristics are not outside the scope of the disclosure and may be desirable for particular applications.

What is claimed is:

1. A method of generating street map data comprising:
collecting acceleration, turning, and geolocation data from acceleration sensors, turning sensors, and geolocation systems in at least one vehicle across a plurality of vehicle drive cycles;
predicting a presence of a traffic control device at a geolocation in response to an identified repetitive pattern in the data; and
updating street map data to include the traffic control device at the geolocation.

2. The method of claim 1, wherein the identified repetitive pattern comprises a plurality of vehicle stops at the geolocation across a plurality of drive cycles.

3. The method of claim 2, further comprising defining a first time interval corresponding to a vehicle stop at a stop sign, a second time interval corresponding to a vehicle stop at a crosswalk, a third time interval corresponding to a yield sign, and a fourth time interval corresponding to a traffic light, and wherein predicting a presence of a traffic control device at a geolocation comprises correlating the plurality of vehicle stops with one of the first, second, third, and fourth time intervals.

4. The method of claim 2, further comprising defining a first stop probability corresponding to a vehicle stop at a stop sign, a second stop probability corresponding to a vehicle stop at a crosswalk, a third stop probability corresponding to a yield sign, and a fourth stop probability corresponding to a traffic light, and wherein predicting a presence of a traffic control device at a geolocation comprises correlating a percentage of vehicle trips through the geolocation that are vehicle stops at the geolocation with one of the first, second, third, and fourth stop probability.

5. The method of claim 1, wherein predicting a presence of a traffic control device at a geolocation in response to an identified repetitive pattern in the data comprises predicting the presence of a stoplight at an intersection in response to an identified geolocation at which a pattern of first and second driving modes occurs, the first mode including driving toward and through the intersection at a first heading without stopping and the second mode including driving toward the intersection at the first heading and stopping before driving through.

6. A mapping system comprising:
one or more computing devices configured to
aggregate collected data including driver actuations of vehicle controls at corresponding geolocations;
infer a presence of a discrepancy in mapping data in response to an identified repetitive driving pattern at one of the geolocations among the aggregated data; and
update the mapping data to correct the discrepancy.

7. The system of claim 6, wherein the driver actuations of vehicle controls include accelerator pedal actuation, brake pedal actuation, or steering wheel rotation.

8. The system of claim 6, wherein inferring a presence of a discrepancy in mapping data includes predicting a presence of a traffic control device in response to a plurality of vehicle stops at the one of the geolocations at which no traffic control device is indicated in the mapping data.

9. The system of claim 6, wherein inferring a presence of a discrepancy in mapping data includes predicting a presence of a road in response to a plurality of vehicle turns from a first vehicle heading to a second vehicle heading at the one of the geolocations at which no road is indicated in a direction of the second vehicle heading.

10. A method of generating mapping data comprising:
generating mapping data including a predicted geolocation of a traffic control device predicted in response to a repeated driving pattern at the geolocation, the repeated driving pattern being identified among collected acceleration, turning, and geolocation data from acceleration sensors, turning sensors, and geolocation systems in at least one vehicle across a plurality of vehicle drive cycles.

11. The method of claim 10, wherein the repeated driving pattern comprises a plurality of vehicle stops at the geolocation across the plurality of drive cycles.

12. The method of claim 11, further comprising defining a first time interval corresponding to a vehicle stop at a stop sign, a second time interval corresponding to a vehicle stop at a crosswalk, a third time interval corresponding to a yield sign, and a fourth time interval corresponding to a traffic light, and wherein the geolocation of the traffic control device is predicted in response to correlating the plurality of vehicle stops at the geolocation with one of the first, second, third, and fourth time intervals.

13. The method of claim 11, further comprising defining a first stop probability corresponding to a vehicle stop at a stop sign, a second stop probability corresponding to a vehicle stop at a crosswalk, a third stop probability corresponding to a yield sign, and a fourth stop probability corresponding to a traffic light, and wherein the geolocation of the traffic control device is predicted in response to correlating a percentage of vehicle trips through the geolocation that are vehicle stops with one of the first, second, third, and fourth stop probabilities.

14. The method of claim 10, wherein the traffic control device is a stoplight, and wherein the repeated driving pattern at the geolocation includes a pattern of first and second driving modes, the first mode including driving toward and through an intersection at a first heading without stopping and the second mode including driving toward the intersection at the first heading and stopping before driving through.
